(19) United States
(12) Patent Application Publication
(10) Pub. No.: US 2022/0214841 A1
(43) Pub. Date: Jul. 7, 2022

(54) PRINTERS WITH TRANSPARENT DISPLAYS

(71) Applicant: Hewlett-Packard Development Company, L.P., Spring, TX (US)

(72) Inventors: Ranganath Malleshappa, Bangalore (IN); Divya Arunagiri, Bangalore (IN)

(73) Assignee: Hewlett-Packard Development Company, L.P., Spring, TX (US)

(21) Appl. No.: 17/609,444

(22) PCT Filed: Jun. 22, 2020
(86) PCT No.: PCT/US20/38919

§ 371 Date: Nov. 8, 2021

(30) Foreign Application Priority Data
Sep. 17, 2019 (IN) IN201941037408

(51) Int. Cl. G06F 3/12; G06F 3/01; G06F 3/041

(52) U.S. Cl. CPC G06F 3/1205; G06F 3/013; G06F 3/1284; G06F 3/1258; G06F 3/041

(57) ABSTRACT

An example printer includes a housing and a print mechanism disposed within the housing. The print mechanism is to print a document to a print medium. The example printer further includes a transparent display positioned at the housing. The transparent display is to display information related to operation of the print mechanism. The transparent display is positioned to allow viewing of the print mechanism from outside the housing.

### BACKGROUND

Printer user interfaces include buttons, switches, and display devices. A user may provide direct input to a printer by, for example, processing a button on the printer. The printer may provide information to the user, for example, by displaying information to the user on a screen attached to the printer.

### BRIEF DESCRIPTION OF THE DRAWINGS

FIG. 1 is a perspective view of an example printer with a transparent display.

FIG. 2 is a diagram of positioning a user-interface element on a transparent display of an example printer.

FIG. 3 is a diagram of example dimensions to locate a user-interface element on a transparent display of a printer.

FIG. 4 is a diagram of an example user interface for a transparent display of a printer, where the user interface includes a menu.

FIG. 5 is a diagram of an example user intervention alert for a transparent display of a printer.

FIG. 6 is a diagram of an example user interface for a transparent display of a printer, where the user interface includes opaque and transparent regions.

FIG. 7 is a diagram of an example user interface for a transparent display of a printer, where the user interface includes an outline of a printer mechanism component.

FIG. 8 is a block diagram of an example printer with a transparent display.

FIG. 9 is a perspective view of the example printer of FIG. 1 with a front panel that carries the transparent display opened.

### DETAILED DESCRIPTION

Many printer user interfaces use a screen to attempt to inform a user of an operation being carried out by the printer or a state of the printer. For example, a printer's screen may display messages, such as “printing page 3 of 5.”

Similar concepts are used to display menus at a printer and to instruct a user to manually intervene when the printer encounters an error, such as a paper jam. In an example of the former, a printer's menus may provide on-screen feedback that does not coincide with an apparent operation or apparent lack of operation of a print mechanism. For example, a user may use a menu to print a document from a memory stick and the printer may display a message to inform the user that the document is printing, but the user may not immediately see or hear a physical response from the printer. This may lead the user to believe that the document is not actually printing.

In an example of the latter, a printer may display diagrammatic or textual instructions to the user. However, when the user opens the printer to make the manual intervention, the user may not be able to readily associate the instructions to the actual mechanism that he/she sees.

A transparent display may be provided to a printer to provide augmented-reality functionality to the printer, so that a user may interact with information on the display and see inside the printer through the display.

A user is able to view the interior of the printer through the transparent display. The transparent display may provide information about the printer to the user and, at the same time, allow the user to view an interior mechanism of the printer. A user interface displayed at the transparent display juxtaposed with actual physical state of the printer may directly inform the user that the printer responded to an input Further, in the case of a jam or other malfunction, a transparent display may be capable of instructing the user to perform a manual intervention in the context of the actual mechanism of the printer.

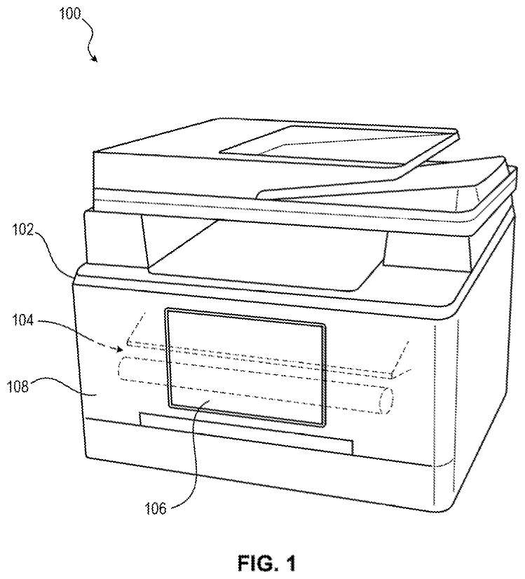

FIG. 1 shows an example printer 100, The printer 100 may be an inkjet printer, a laser printer, a multifunction device (e.g., printer with integrated scanner, copying, fax functionality, etc.), or similar device capable of generating a printed document.

The printer 100 includes a housing 102 and a mechanism 104 disposed within the housing.

The mechanism 104 prints a document to a print medium, such as paper, cardstock, polymer film, or similar. The mechanism 104 may include electromechanical components such as a roller, a tray, an inkjet cartridge, an inkjet printhead, a conveyor, a drum, a laser device, a fuser, a toner cartridge, and similar. The specific components of the mechanism 104 depend on the type of printer and its functionality.

The printer 100 further includes a transparent display 106 positioned at the housing 102. In this example, the transparent display 106 is positioned in a front panel 108 of the housing 102. The front panel 108 may provide an external surface to the housing 102 that normally faces a user when the user interacts with the printer 100. The transparent display 106 acts as a window to directly view inside the printer 100 while also being capable of providing interaction with the user.

The transparent display 106 s to display information related to operation of the mechanism 104. Displayed information may include print options (e.g., single-sided or double-sided printing, paper select, etc.), printer commands that may be selected (e.g., print from a memory stick, cancel a print job, copy a document, etc.), print job status (e.g., page number currently being printed, number of documents in queue, document name, errors, etc.), jam recovery assistance (e.g., an instruction to a user to perform a manual intervention to clear a jam, eta), or similar.

The transparent display 106 may include a liquid-crystal display (LCD), a light-emitting diode (LED) display, an organic LED display, or similar. The transparent display 106 may include a touchscreen to facilitate user input to the printer 100, For example, the transparent display 106 may include capacitive touch-sensitive elements to receive user input at various locations on the display 106.

The transparent display 106 is positioned to allow viewing of the internal mechanism 104 from outside the housing, As such, the transparent display 106 may display information as augmented-reality information about the mechanism 104. That is, a portion of the mechanism 104 may be viewed through the transparent display 106 at the same time that information is displayed on the transparent display 106. This may be useful when instructing a user to undertake manual intervention to clear a jam. For example, the transparent display 106 may display an arrow that points to the location of the jam at the mechanism 104.

The transparent display 106 may provide the user with a way to view the mechanism 104 without having to open the front panel 108. This may assist the user in understanding that the printer 100 is carrying out operations, which may be particularly useful if the printer 100 operates quietly. For example, the user may initiate printing of document using a button displayed at the transparent display 106. In response, the user may see the printer mechanism 104 begin its movement, thereby immediately and directly confirming to the user that the commandwas followed.

The transparent display 106 may be fully transparent, semitransparent, or translucent, provided that a user is able to see through the display 106 to some extent.

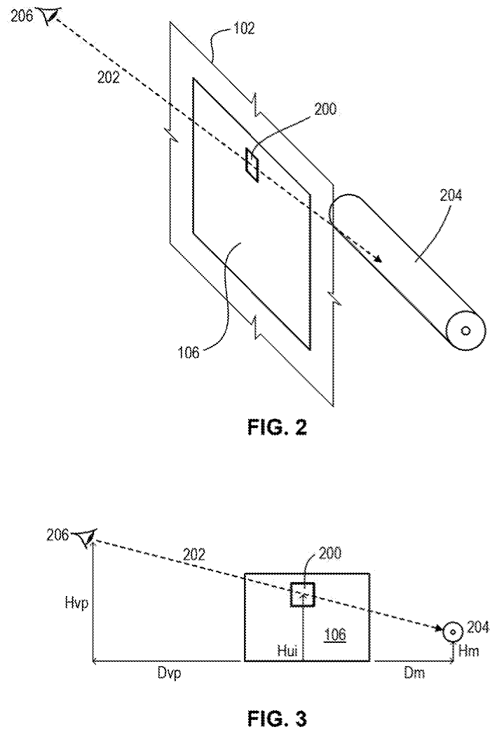

As shown in FIG. 2, an example transparent display 106 may be used to display a user-interface element 200, such as an icon, word, image, graphic, animation, video, symbol, touch-sensitive button or region, or the like. The user-interface element 200 may be positioned at a position along a line of sight 202 between a component 204 of the printer mechanism and a viewpoint 206 outside a housing 102 at which the tray s arent>display 106 is located.

Positioning a user-interface element 200 along a line of sight 202 between a user and a component 204 of the printer mechanism may assist the user in clearing a jam or undertaking another manual intervention. The user-interface element 200 may indicate a user action to be performed and a location of the action at the mechanism. For example, an arrow may be displayed on the transparent display 106 and point to a lever inside the printer that a user is instructed to move to assist in clearing a jam. The arrow may be positioned so that, from the perspective of the user, the arrow points to the lever. In another example, a colored outlined box is shown to indicate where a release for a toner cartridge is located when the printer detects that the toner cartridge is to be replaced. In another example, a colored region or outline traces a shape of a component 204, in still another example the transparent display 106 may be made opaque by displaying a color, such as the same color of the housing, except for a region that allows the user to see the internal location requiring intervention. As such, the transparent display 106 may be selectively and dynamically windowed to draw the user's attention to particular locations within the printer.

The transparent display 106 may therefore display augmented-reality information about the mechanism. That is, a transparent region of the naparent display 106 allows the user to see'the actual mechanism inside the printer, while simultaneously a user-interface element 200 displayed on the transparent display 106 may be juxtaposed with the mechanism to provide information beyond the appearance of the mechanism.

As shown it FIG. 3, the height Hui of a user-interface element 200 on the transparent display 106 may be selected based on an expected height Hvp of a user's eye, an expected distance Dvp of the users eye from the transparent display 106, a height Hm of an internal component 204 of the printer mechanism, and a distance Dm of the internal component 204 of the printer mechanism from the transparent display 106. The heights Hvp, Hui, Hm and distances Dvp, Dm may refer to the same reference, such as an expected position of the bottom of the transparent display 106. In other words, the user-interface element height Hui may be computed by linear interpolation between the expected user viewpoint height Hvp and distance Dvp and the mechanism height Hm and distance Dm. Thus, the user-interface element 200 may be displayed at a location that makes sense to a user who views the internal component through the transparent display 106. While the mechanism height Hm and distance Dm are fixed or predictable, the expected viewpoint height Hvp and distance Dvp may be predefined based on an average empirical measure (e.g., based on typical users in typical situations) or may be user-selectable or configurable. Similarly, the reference may be predefined, selectable, or configurable. For example, the user may be able to select the height of the table that the printer is placed on, so that the reference (e.g., the bottom of the transparent display 106) is accurate.

In other examples, a user-interface element 200 may be positioned on a transparent display 106 using eye tracking. For example, a camera may be provided to the printer 100 and a processor of the printer 100 may be programmed to perform eye tracking to determine a user's viewpoint, e.g., Dvp and Hvp. The user-interface element 200 may then be positioned on the transparent display 106 based on the user's viewpoint. Further, the interface element 200 may be moved or animated on the transparent display 106 in response to movement of the user's viewpoint, as determined by eye tracking.

The above, whether using preset or selectable positions or using eye tracking, may be used to overlap or place a user-interface element 200 near an internal component 204, which may be useful if the user-interface element 200 is used to highlight or indicate the component 204. Conversely, the above may be applied to avoid overlap or provide space between a menu item, button, or other user-interface element 200 with respect to a component 204, when a clear view of the component 204 is desired. That is, the user-interface element 200 may be positioned to outside the line of sight 202.

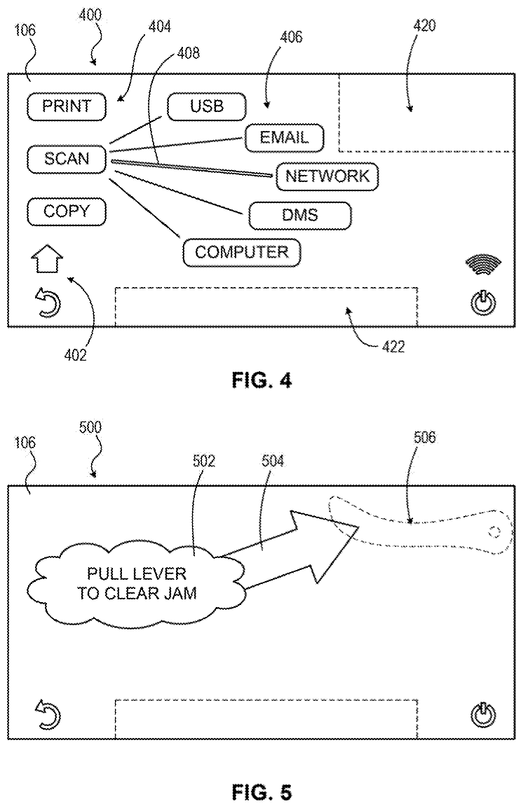

FIGS. 4-7 show example user-interface elements that may be displayed on a transparent display 106 of a printer 100.

FIG. 4 shows an example user interface 400 that includes icons 402, such as cons to navigate the user interface 400 (e.g., a home icon, a back icon, eta), an icon to power on/off the printer, an icon to indicate a wireless signal strength and/or turn on/off a wireless communications interface. The transparent display 106 may be a touchscreen and an icon 402 may be touch-sensitive.

The user interface 400 may include menu items 404, such as text indications of functions available at the printer. A menu item 404 may be expandable to display relevant submenu items 406. An expanded menu item 404 may remain open when displaying submenu items 406, so that the user may view a menu tree and may understand the scope of his/her past or potential choices.

The user interface 400 may guide the user through a sequence of steps to operate the printer. Animation may be displayed on the transparent display 106 to bring the user's attention to a choice that may be made through the menu items 404 or submenu items 406. For example, a linking graphic 408, such as a line, or arrow, between a menu item 404 and submenu item 406 may animate to bring, the user's attention to the submenu item 406.

Elements of the user interface 400, such as ions 402 and menu items 404, 406, may be arranged to allow a component 420, 422 of a mechanism inside the printer to be visible. That is, elements of the user interface 400 may be positioned based on a location of a component 420, 422, so that the component is visible from an expected user viewpoint. As such, the user may be able to see, at the same time, both the user interface 400 on the transparent display 106 and a component 420, 422 of the mechanism behind the transparent display 106. As such, movement of a component 420, 422 of the mechanism may be readily apparent to the user. When such movement is in response to a menu item 404, 406 selected by the user, the user may be provided with immediate physical feedback of his/her selected action.

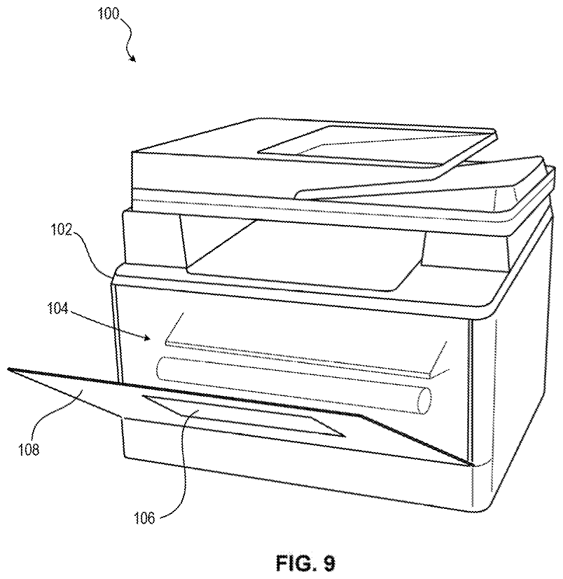

FIG. 5 shows an example user interface 500 displayable on a transparent display 106 of a printer. The user interface 500 indicates an alert that instructs a user on how to manually intervene to clear a jam. The user interface 500 may include a text instruction 502 and a target indicator 504, such as an arrow or box, to indicate the component 506 inside the printer that is to be manually actuated. The text instruction 502 and target indicator 504 may highlight the actual physical intervention that is needed with the actual component 506 in view. The user may then open the printer, such as by opening the front panel on which the transparent display 106 is mounted, to carry out the intervention (FIG. 9).

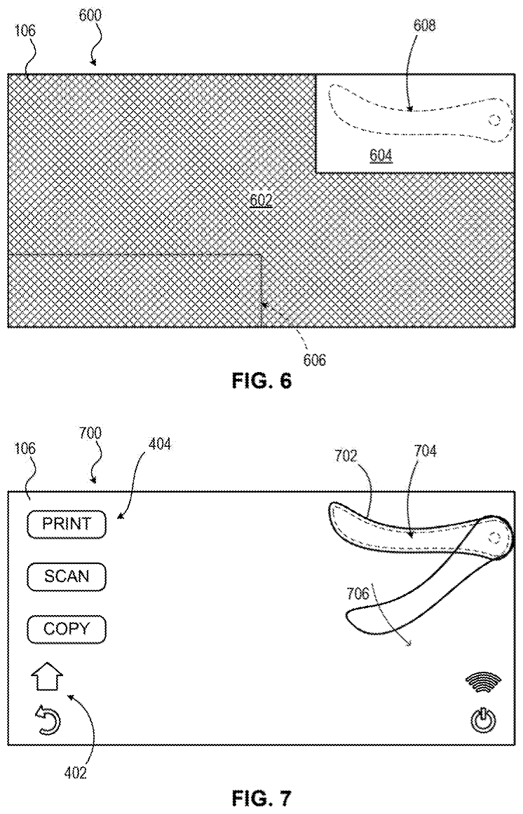

FIG. 6 shows an example user interface 600 displayable on a transparent display 106 of a printer. The user interface 600 displays an opaque or semi-opaque region to occlude or obscure a component 606 of a printer echanism and a transparent or semitransparent region to allow the viewing of another component 608 of a printer mechanism. The user interface 600 may bring the users attention to the component 608 while diverting the users attention away from the other component 606.

FIG. 7 shows an example user interface 700 displayable on a transparent display 106 of a printer. The user interface 700 displays an outline 702 of a component 704 of a printer mechanism to bring a user's attention to the component 704. The outline 702 may have a color that contrasts with the internal components of the printer, The outline 702 may be animated. An animation 706 may, for example, demonstrate how the component is to be manually moved by the user, In other examples, the solid region in the shape of the component 704 may be displayed or animated.

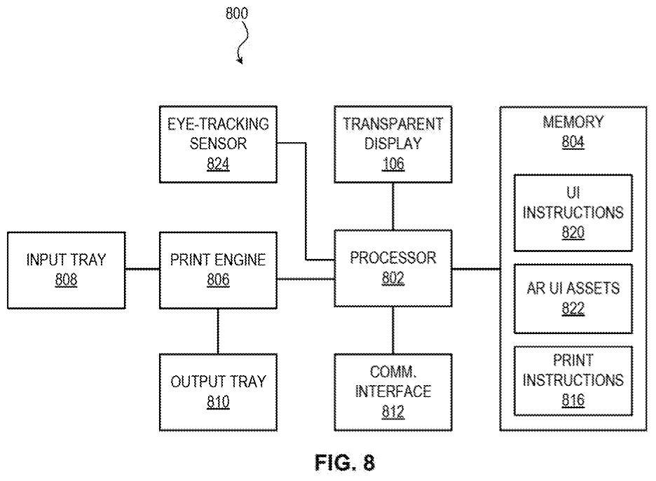

FIG. 8 shows an example printer 800 that includes a transparent display 106. The printer 800 may be similar to the printer 100. The description for the printer 100 may he referenced for details not repeated here.

The printer 800 may include a processor 802, memory 804, and a print engine 806.

The processor 802 may be coupled to the print engine 806 to control the print engine 806, The processor 802 may be coupled to the memory 804 to communicate instructions and data therebetween to provide for execution of instructions by the processor 802. The processor 802 may include a central processing units (CPU), a microcontroller, a microprocessor, a processing core, a field-programmable gate array (FPGA), or similar device capable of executing instructions.

The memory 804 may include a non-transitory machine-readable storage medium that may be any electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, and the like. The machine-readable storage medium may be encoded with executable instructions, The memory 804 may store print instructions 814 that are executable by the processor 802 to control the print engine 806 to print information to print media.

The print engine 806 may include a mechanism to print a document to a print medium. The print engine 806 may include a roller, an inkjet cartridge, an inkjet printhead, a conveyor, a drum, a laser device, a fuser, a toner cartridge, a motor, servomotor, a gear assembly, a power circuit, and similar. The print engine 806 may include various electromechanical components to perform a specific type of printing.

The printer 800 may further include a print media input tray 808 nd a printed media output tray 810, each connected to the print engine 806.

The printer 800 may further include a communications interface 812 coupled to the processor 802 to communicate with a computer network to receive print jobs from computers on the computer network. The printer 800 may include a communications port, such as a serial port, to receive a print job from a directly connected computer.

The transparent display 106 may be connected to the processor 802. The processor 802 may drive the transparent display 106 to display a user interface, which may be represented by instructions 820 stored in memory 804, to allow user interaction with the printer 100. The user-interface instructions 820 may reference augmented-reality user-interface assets 822, which may be stored in the memory 804. The augmented-reality user-interface assets 822 may include graphics, animations, images, icons, text. and the like, as mentioned elsewhere herein.

The processor 802 may execute the user-interface instructions 820 to display augmented-reality user-interface assets 822 that provide information to a user, or accept input from the user, in temporal or spatial juxtaposition with a component of the print engine 806 that is viewable through the transparent display 106. The user-interface instructions 820 and augmented-reality user-interface assets 822 may implement any of the example user interfaces and user interface elements discussed herein.

The printer 800 may further include an eye-tracking sensor 824, such as a camera, connected to the processor 802, The eye-tracking sensor 824 may be aimed towards a location in the vicinity of the printer 800 where a user's face is expected to be during normal user interaction with the printer 800. The user-interface instructions 820 may include instructions to determine a user's viewpoint based on a signal outputted by the eye-tracking sensor 824, and then position a user-interface asset 822 at an appropriate location on the transparent display 106. That is, an icon, word, image, or other user-interface asset 822 may be dynamically positioned on the transparent display 106 based on a sensed eye position and/or viewing direction of the user. This may allow for a user-interface asset 822 to be positioned with respect to internal mechanism of the printer 800 as viewed by the user through the transparent display 106. A user-interface asset 822 may be positioned based on eye tracking to apparently overlap or to be in apparent proximity to a component of the mechanism (e.g., to indicate a jam) or may be positioned based on eye tracking to provide an unobstructed view of a component of the mechanism (e.g., to give direct feedback to the user).

FIG. 9 shows a front panel 108 of a printer 100, which carries a transparent display 106, in an opened position to grant a user manual access to an internal mechanism 104 of the printer 100. A user may thus perform a manual intervention on the printer 100, close the front panel 108, and then view the result of the manual intervention through the transparent display 106 in conjunction with related information that may be displayed on the transparent display 106.

In view of the above, it should be apparent that a transparent display may be provided to a printer to provide useful information to a user of the printer in conjunction with the ability to see an internal mechanism of the printer. A user may thus gain a better understanding of the printer and its operations Further, a user may be taught or instructed how to manually intervene in the visible context of the printer mechanism, in the case of an operational problem with the printer, such as a paper jam.

It should be recognized that features and, aspects of the various examples provided above can be combined into further examples that also fall within the scope of the present disclosure. In addition, the figures are not to scale and may have size and shape exaggerated for illustrative purposes.

1. A printer comprising:
a housing;
a print mechanism disposed within the housing, the print mechanism to print a document to a print medium; and
a transparent display positioned at the housing, the transparent display to display information related to operation of the print mechanism, the transparent display positioned to allow viewing of the print mechanism from outside the housing.

2. The printer of claim 1, wherein:
the housing comprises a front panel; and
the transparent display is positioned in the front panel.

3. The printer of claim 1, wherein the transparent display is to display a user-interface element at a position along a line of sight between a component of the print mechanism and a viewpoint outside the housing.

4. The printer of claim 3, wherein the user-interface element is to indicate a manual intervention to clear a jam of the print medium at the component of the print mechanism.

5. The printer of claim 1, wherein the transparent display is to display the information as augmented-reality information about'the print mechanism.

6. The printer of claim 1, wherein the transparent display is to display an expandable menu.

7. The printer of claim 1, wherein the transparent display comprises a touchscreen.

8. A printer comprising:
a housing;
a print mechanism disposed within the housing, the print mechanism to print a document to a print medium; and
a transparent display positioned at the housing, the transparent display to simultaneously display augmented-reality information about the print mechanism and allow viewing of the print mechanism through the transparent display.

9. The printer of claim 8, further comprising a processor, wherein the processor is to display the augmented-reality information on the transparent display at a position based on a position of a component of the print mechanism in the housing.

10. The printer of claim 8, wherein the augmented-reality information comprises at least one of an expandable menu tree or an animation.

11. The printer of claim 8, further comprising a processor, wherein the processor is to display the augmented-reality information on the transparent display at a position based on eye tracking.

12. The printer of claim 8, wherein the augmented-reality information comprises a transparent region to allow viewing of a component of the print mechanism and an opaque region to occlude or obscure another component of the print mechanism.

13. The printer of claim 8, further comprising a processor, wherein the processor is to display the augmented-reality information on the transparent display at a position outside a line of sight between a component of the print mechanism and a viewpoint outside the housing.

14. A non-transitory machine-readable medium comprising instructions that when executed by a processor cause the processor to:
to display information related to operation of an internal print mechanism of a printer on a transparent display at a housing of the printer to allow simultaneous viewing of the information and the internal print mechanism.

15. The non-transitory machine-readable medium of claim 14, wherein the information comprises a user-interface element to indicate a manual intervention for the internal print mechanism.
